(19) United States
(12) Patent Application Publication
(10) Pub. No.: US 2013/0164992 A1
(43) Pub. Date: Jun. 27, 2013

(54) UNIVERSAL SERIAL BUS PLUG

(71) Applicants: YI-HUNG HSIEH, Tu-Cheng (TW); CHIEN-YI LI, Tu-Cheng (TW)

(72) Inventors: YI-HUNG HSIEH, Tu-Cheng (TW); CHIEN-YI LI, Tu-Cheng (TW)

(73) Assignee: HON HAI PRECISION INDUSTRY CO., LTD., Tu-Cheng (TW)

(21) Appl. No.: 13/482,480

(22) Filed: May 29, 2012

(30) Foreign Application Priority Data
Dec. 26, 2011 (TW) 100148671

(51) Int. Cl. H01R 24/28

(52) U.S. Cl. 439/668

(57) ABSTRACT

A Universal Serial Bus (USB) plug includes a main body and a mating member. The main body includes a front side and a back side. The mating member extends from the front side of the main body. The mating member is adapted to insert into a USB port of an electronic device. The length of the main body is less than 3.16 millimeters and the total length of the main body and the mating member is less than 12.0 millimeters.

### BACKGROUND

1. Technical Field

The present disclosure generally relates to a connector, and particularly relates to a Universal Serial Bus (USB) plug.

2. Description of Related Art

The Universal Serial Bus (USB) interface, which has functions of Plug and Play (PNP), hot insertion/hot swap-ping and the like, is the most popular data transmission interface applied for peripheral devices nowadays. More and more peripheral devices include a USB interface to increase the expandability thereof for various applications.

As shown in FIG. 1, a conventional electronic device 100 has a plurality of USB ports 102 disposed therein and arranged in a spaced manner. The conventional electronic device 100 is applicable for a plurality of USB plugs 900 respectively having a main body 902 and a mating member 904 to be plugged in at the same time. However, if the USB plug 900 is not a standard USB plug, the main body 902 of the USB plug 900 may be too wide and interfere with the other USB plugs 900. As shown in FIG. 1, the USB plug 900 inserted into one of the USB ports 102 is not a standard USB plug and has such a wide main body 902 that another standard USB plug cannot be plugged in the adjacent USB port 102 because there is insufficient space to accommodate a standard USB plug.

Referring to FIGS. 2-4, a standard USB plug 910 is shown according to the USB Revision 2.0 Specification, which is released by USB Implementers Forum, Inc. (http://www.usb.org) on Apr. 27, 2000. The USB Revision 2.0 Specification provides the requirements for USB interconnect, which includes the dimensions, materials, electrical, and reliability requirements. The standard USB plug 910 includes a main body 912 and a mating member 914 extending from a front side of the main body 912. The length of the main body 912 is 27.0 millimeters. The width of the main body 912 is 15.7 millimeters. The length of the mating member 914 is 12.0 millimeters. The mating member 914 includes a resisting portion 911 made of electrical insulating materials such as plastics and a plurality of contacting fingers 915 made of electrical conducting materials such as metal. The mating member 914 defines a cavity 913 for receiving the plurality of contacting fingers 915. The length of the cavity 913 is 8.65±0.19 millimeters such that the mating member 914 can be inserted into a USB port for a depth range of 8.46 to 8.84 millimeters. Accordingly the length of the resisting portion 911 can be calculated to be between 3.16 and 3.54 millimeters. Namely, the length range of 3.16 to 3.54 millimeters is the length range of a portion of the mating member 914, which is exposed out of a USB port when the mating member 914 is inserted into the USB port.

Therefore, it is desirable to provide an improved USB plug which can solve the above mentioned shortcomings

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of an application of conventional USB plug.

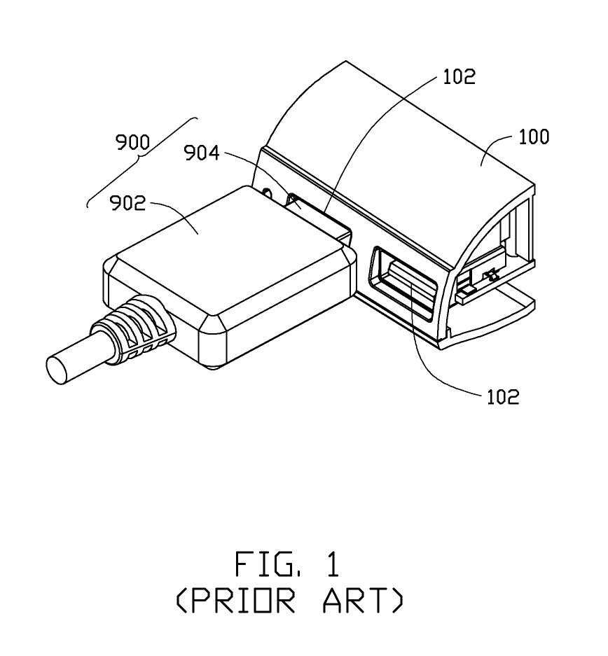

FIG. 2 is a top view of a standard USB plug according to the USB Revision 2.0 Specification.

FIG. 3 is a front view of the standard USB plug of FIG. 2.

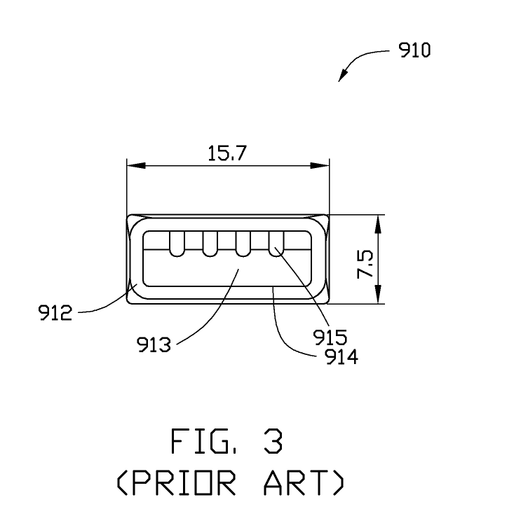

FIG. 4 is a cross-sectional view of the standard USB plug of FIG. 4.

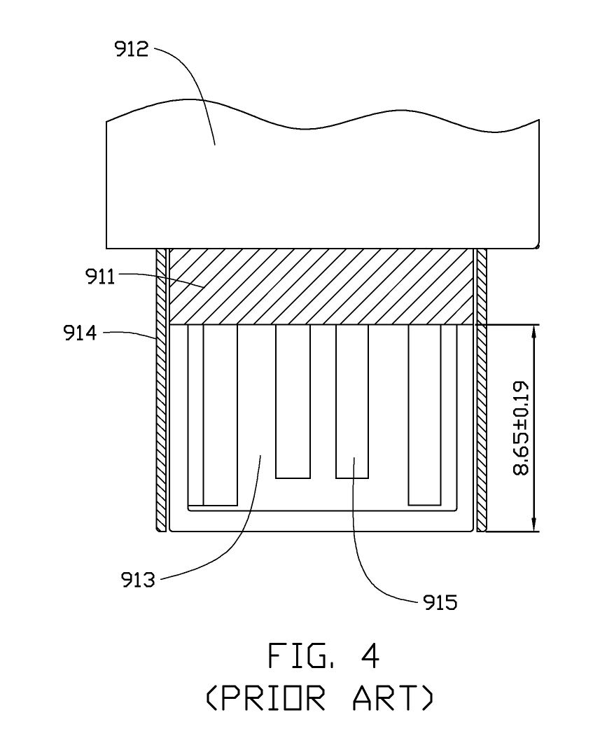

FIG. 5 is a perspective view of an improved USB plug in accordance with an embodiment of the present invention.

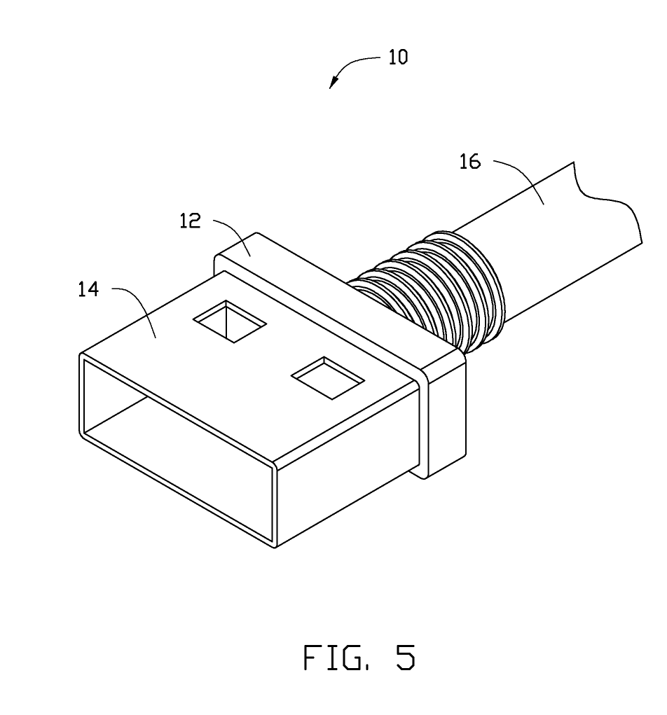

FIG. 6 is a top view of the improved USB plug of FIG. 5.

FIG. 7 is a front view of the improved USB plug of FIG. 5.

FIG. 8 is a perspective view of an application of the improved USB plug of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

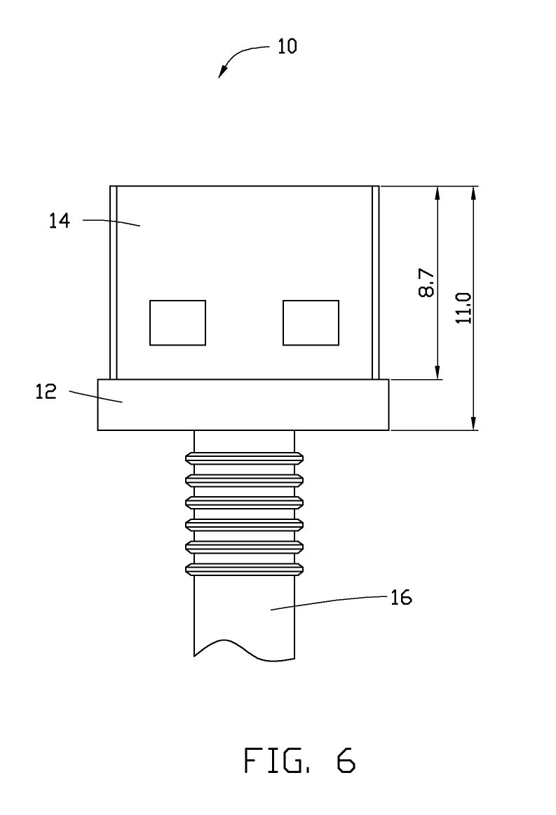

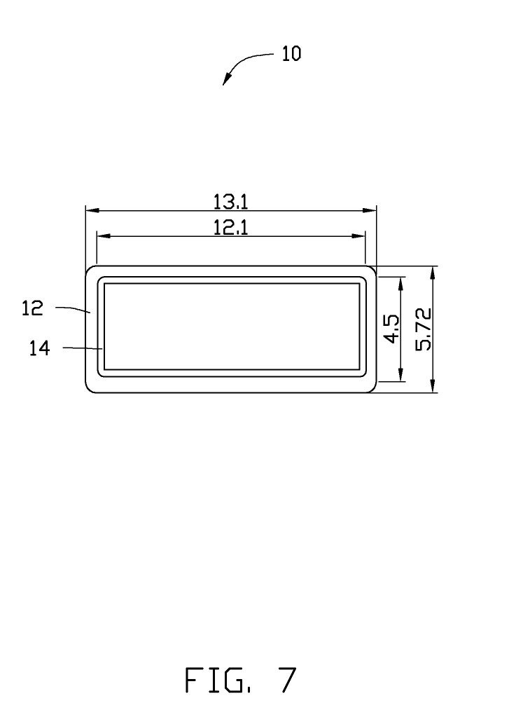

FIGS. 6-7, show an improved USB plug 10 in accordance with an embodiment of the present invention. The improved USB plug 10 includes a main body 12, a mating member 14, and a cable 16. The mating member 14 extends from a front side of the main body 12. The cable 16 includes two ends. One end of the cable 16 is connected to a back side of the main body 12 and the other end of the cable 16 may be connected to a downstream USB interface or a peripheral device.

The mating member 14 defines a cavity (not labeled) and includes a plurality of contacting fingers (not shown). The mating member 14 may be inserted into the USB port 102 of the electronic device 100 thereby establishing an electrical connection between the improved USB plug 10 and the electronic device 100.

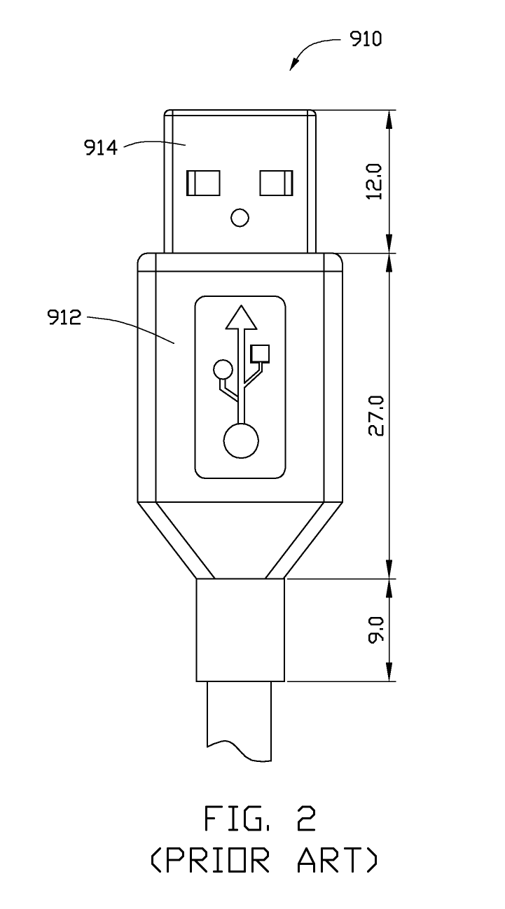

The main body 12 is substantially cuboid in shape and coated with electrical insulating materials such as plastic. The length of the main body 12 is less than 3.16 millimeters. The total length of the main body 12 and the mating member 14 is less than 12.0 millimeters. The width of the main body 12 is less than 15.7 millimeters so as to avoid interfering with the other standard USB plug as shown in FIG. 2. In an embodiment, the width of the main body is 13.1 millimeters.

In order to ensure that the mating member 14 fully contacts with the USB port 102, the length of the mating member 14 is defined between 8.46 and 8.84 millimeters. In an embodiment, the length of the mating member 14 is 8.7 millimeters.

In some embodiments, the total length of the main body 12 and the mating member 14 is 11.0 millimeters. The length of the main body 12 is 2.3 millimeters and the length of the mating member is 8.7 millimeters.

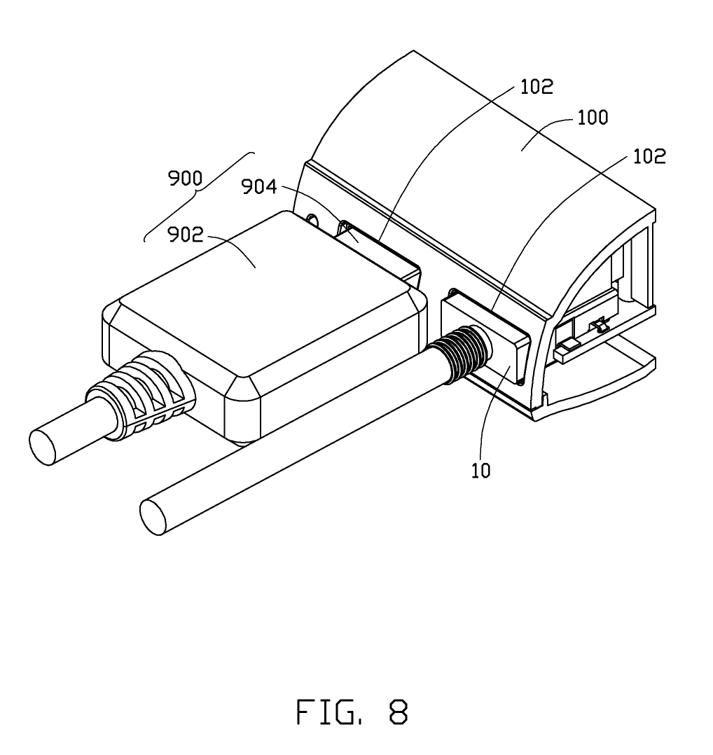

FIG. 8 shows an application of the improved USB plug 10 being plugged in the electronic device 100. Because the total length of the main body 12 and the mating member 14 is less than 12.0 millimeters, which is less than the length of the mating member 914 of the standard USB plug 910, and the length of the main body 12 is less than 3.16 millimeters, which is less than the length of the resisting portion 911 of the standard USB plug 910, the improved USB plug 10 does not interfere with the USB plug 900 or the standard USB plug 910.

It is to be understood, however, that even though numerous characteristics and advantages have been set forth in the foregoing description of embodiments, together with details of the structures and functions of the embodiments, the disclosure is illustrative only and changes may be made in detail, especially in matters of shape and arrangement of parts within the principles of the disclosure to the full extent indicated by the broad general meaning of the terms in which the appended claims are expressed.

What is claimed is:

1. A Universal Serial Bus (USB) plug, comprising:
a main body comprising a front side and a back side;
a mating member extending from the front side, the mating member is configured to be inserted into a USB port of an electronic device;
wherein a length of the main body is less than 3.16 millimeters and a total length of the main body and the mating member is less than 12.0 millimeters.

2. The USB plug of claim 1, wherein the length of the mating member is between 8.46 millimeters and 8.84 millimeters.

3. The USB plug of claim 2, wherein a length of the mating member is 8.7 millimeters.

4. The USB plug of claim 1, wherein the total length of the main body and the mating member is 11.0 millimeters.

5. The USB plug of claim 1, wherein a width of the main body is less than 15.7 millimeters.

6. The USB plug of claim 5, wherein the width of the main body is 13.1 millimeters.

7. The USB plug of claim 1, further comprising a cable connecting to the back side of the main body.

8. The USB plug of claim 1, wherein the main body is substantially cuboid in shape.

9. The USB plug of claim 1, wherein the main body is coated with electrical insulating materials.

10. A Universal Serial Bus (USB) plug, comprising:
a main body comprising a front side and a back side;
a mating member extending from the front side, the mating member is configured to be inserted into a USB port of an electronic device;
wherein a width of the main body is less than 15.7 millimeters and a total length of the main body and the mating member is less than 12.0 millimeters.

11. The USB plug of claim 10, wherein a length of the main body is less than 3.16 millimeters.

12. The USB plug of claim 11, wherein a length of the mating member is between 8.46 millimeters and 8.84 millimeters.

13. The USB plug of claim 12, wherein the length of the mating member is 8.7 millimeters.

14. The USB plug of claim 10, wherein the total length of the main body and the mating member is 11.0 millimeters.

15. The USB plug of claim 10, wherein the width of the main body is 13.1 millimeters.

16. The USB plug of claim 10, further comprising a cable connecting to the back side of the main body.

17. The USB plug of claim 10, wherein the main body is substantially cuboid in shape.

18. The USB plug of claim 10, wherein the main body is coated with electrical insulating materials.
